(19) United States
(12) Patent Application Publication
(10) Pub. No.: US 2025/0081906 A1
(43) Pub. Date: Mar. 13, 2025

(54) IRRIGATION CONTROL SYSTEMS

(71) Applicant: Joseph Malan Jackson, Salem, UT (US)

(72) Inventor: Joseph Malan Jackson, Salem, UT (US)

(21) Appl. No.: 18/830,447

(22) Filed: Sep. 10, 2024

Related U.S. Application Data
(60) Provisional application No. 63/537,616, filed on Sep. 11, 2023.

(51) Int. Cl. A01G 25/16; G06N 20/00

(52) U.S. Cl. CPC A01G 25/165; G06N 20/00

(57) ABSTRACT

A method includes identifying user input associated with sets of environmental data. Each set of environmental data is associated with a corresponding irrigation zone of irrigation zones. The method further includes generating, based on the user input, an irrigation schedule associated with the irrigation zones. The irrigation schedule includes a corresponding time duration for irrigating each irrigation zone. The method further includes receiving, from one or more sensors, sensor data associated with one or more of the irrigation zones. The method further includes updating, based on the sensor data and the user input, the irrigation schedule to generate an updated irrigation schedule. The updated irrigation schedule has one or more different time durations than the irrigation schedule. The method further includes causing, based on the updated irrigation schedule, irrigation of one or more irrigation zones.

### RELATED APPLICATIONS

This application claims the benefit of Provisional Application No. 63/537,616, filed Sep. 11, 2023, which is incorporated by reference in its entirety.

### TECHNICAL FIELD

Aspects and embodiments of the disclosure relate to control systems, and more specifically, to irrigation control systems.

### BACKGROUND

Irrigation systems provide water to plants, lawns, gardens, and agricultural crops. Irrigation systems distribute water over an area for specified periods of time using a network of pipes connected to a water source.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIGS. 1A-B are block diagrams illustrating irrigation control systems, in accordance with some embodiments of the disclosure.

FIGS. 2A-G illustrate irrigation control systems, in accordance with some embodiments of the disclosure.

FIG. 3 is a flow diagram illustrating a method of controlling irrigation control systems, in accordance with some embodiments of the disclosure.

FIGS. 4A-B are flow diagrams illustrating methods of training and using machine learning models associated with controlling irrigation control systems, in accordance with some embodiments of the disclosure.

FIG. 5 is a block diagram illustrating an example computer system, in accordance with some embodiments of the disclosure.

### DETAILED DESCRIPTION

The present disclosure is directed to irrigation control systems (e.g., control systems and interfaces).

Irrigation systems provide water to plants, lawns, gardens, and agricultural crops. Irrigation systems distribute water over an area for specified periods of time using a network of pipes connected to a water source.

There are many types of control systems for controlling the processing and flow of fluid. Some control systems, for example, are used for controlling water flow. By way of example, some conventional irrigation systems may include gates (e.g., irrigation valves) that can be opened and closed to divert flowing water to an area to be irrigated.

Some conventional irrigation systems include sprinklers that can be used to provide flow and direction to the water that is applied to water crops, lawns, landscapes, and other areas through the use of manual and electronic controls that direct water through different irrigation lines.

Conventional irrigation systems are not equipped to adjust the flow of water based on the detected moisture content in the soil. Accordingly, it is not uncommon to see sprinklers being used to irrigate an area while rain is also falling on the same area. Conventional irrigation systems rely on user inputs of preprogrammed times and durations for watering each area by sprinklers.

Conventional irrigation systems that attempt to detect rain and attenuate water flow accordingly are not very successful. In fact, it is well-known that most users of sprinklers with rain sensors end up disconnecting the rain sensors. One reason for this is that the rain sensor does not immediately detect rain, but rather only detects rain once a certain, undesirably high, threshold is met. Therefore, the irrigation systems continue to water the area during a rain event, before the rain has saturated the soil.

Such conventional systems can also suffer from the opposite effects. In particular, a rain sensor may not immediately detect when the rain has stopped, after the rain is initially detected, and such that sometimes conventional irrigation systems may undesirably shut off for days following a single rain event.

Conventional irrigation systems also do not provide a user with a convenient way to pause (e.g., temporarily stop, reduce, turn off) or attenuate water flow from the irrigation system based on dynamic user events. For example, other than turning the system off entirely, users of the current irrigation systems are unable to temporarily pause the irrigation systems for a scheduled event (e.g., a soccer practice or a picnic). Similarly, a user of conventional irrigation systems cannot override the rain sensor and force the irrigation system to resume if there was only a minor amount of rainfall and the user wishes to resume the usual schedule.

Conventional irrigation systems also do not take into account the specific environmental factors of a given irrigation area.

Conventional irrigation systems are very inefficient. Conventional irrigation systems waste water through overwatering, water run-off, watering while the soil is saturated, etc. Conventional irrigation systems can cause stress to plants (e.g., grass, bushes, trees, crops, etc.) by providing too much water or not enough water to plants. As such, conventional irrigation systems can be very dangerous to the environment, can cause water shortages, and can harm plants.

Accordingly, for at least these reasons, as well as for the related expense and environmental concerns, there is an ongoing need and desire for irrigation systems which detect rainfall and other events that affect or that are affected by the moisture and humidity of the area covered by a water irrigation system and that, in response to detected conditions, dynamically suspend and/or resume the flow of water to irrigate the area with a desired quantity of water and at a desired time.

The present disclosure may address these and other shortcomings of conventional systems. irrigation control systems. The present disclosure may include irrigation control systems and methods of using irrigation control systems to adjust water flow based on sensor data (e.g., rain events that are detected by water sensors connected to the irrigation control systems), predictive data (e.g., artificial intelligent (AI) detected events), third-party data (e.g., related to the rain events), and/or user events.

In some embodiments of the present disclosure, a processing device may identify user input associated with a plurality of sets of environmental data (e.g., slope data, soil data, vegetation data, exposure data, etc.). Each set of environmental data of the plurality of sets of environmental data may be associated with a corresponding irrigation zone of a plurality of irrigation zones. The processing device may further generate, based on the user input, an irrigation schedule associated with the plurality of irrigation zones. The irrigation schedule may include a corresponding time duration for irrigating each irrigation zone of the plurality of irrigation zones. The processing device may further receive, from one or more sensors (e.g., rainfall sensor, humidity sensor, soil moisture sensor, imaging sensor, infrared sensor, etc.) sensor data associated with one or more of the plurality of irrigation zones. The processing device may further update, based on the sensor data and the user input, the irrigation schedule to generate an updated irrigation schedule. The updated irrigation schedule may have one or more different time durations than the irrigation schedule. The processing device may further cause, based on the updated irrigation schedule, irrigation of one or more irrigation zones of the plurality of irrigation zones.

The irrigation control systems and processes of the present disclosure may be configured to receive user input which may allow a user to reactively and proactively attenuate water flow from the irrigation control system. In some embodiments, the irrigation control system is configured to detect rain in quantities as low as 1/100th of an inch (e.g., 0.01 inches), and/or detect the one of a first rain drops that falls. In some embodiments, the irrigation control system is configured to detect humidity above a certain threshold.

In some embodiments, the irrigation control system is configured to predict an anticipated rain event based on third-party data (e.g., weather forecast data, social media posts, and/or other data). In some embodiments, the irrigation control system uses AI (e.g., trained machine learning model) that uses sensor data and/or image data as input to predict rainfall and to estimate a quantity of rainfall that is to affect different coverage areas of the irrigation control system.

In some embodiments, the irrigation control system automatically pauses (e.g., stops) or resumes (e.g., allows) irrigation (e.g., water flow) based on detected user events (e.g., scheduled play or event at a venue where the irrigation takes place). The irrigation control system of the present disclosure may include a mobile app and/or web interface which allows a user to monitor and provide control inputs for modifying the flow and schedule of the irrigation at the different stations of the irrigation control system.

The present disclosure provides technical advantages over conventional solutions. In some embodiments, the present disclosure may be equipped to adjust the flow of water based on the detected moisture content in the soil. In some embodiments, the present disclosure may immediately detect when rain has stopped, after the rain is initially detected, and such that embodiments of the present disclosure may not undesirably shut off for long periods of time following a single rain event. In some embodiments, the present disclosure may provide a user with a convenient way to pause (e.g., stop, close the irrigation valves) or attenuate (e.g., reduce flow through or reduce time duration of flow through irrigation valves) water flow from the irrigation system based on dynamic user events. In some embodiments, the present disclosure may take into account the specific environmental factors of a given irrigation area. In some embodiments, the present disclosure may conserve water through preventing overwatering, water run-off, watering while the soil is saturated, etc. In some embodiments, the present disclosure may prevent stress to plants by providing an appropriate amount of water to plants. In some embodiments, the present disclosure may benefit the environment by helping to prevent water shortages and harm to plants.

Although some embodiments of the present disclosure are described with regards to rain sensors or humidity sensors, in some embodiments, the present disclosure can use other types of sensors, such as moisture soil sensors, imagery sensors (e.g., camera), infrared sensors, etc.

Having just described some of the various high-level features and benefits of the disclosed embodiments, attention will now be directed to the Figures, which illustrate various conceptual representations, architectures, methods, and/or supporting illustrations related to the disclosed embodiments. The present disclosure is illustrated by way of example, and not by way of limitation in the figures of the accompanying drawings.

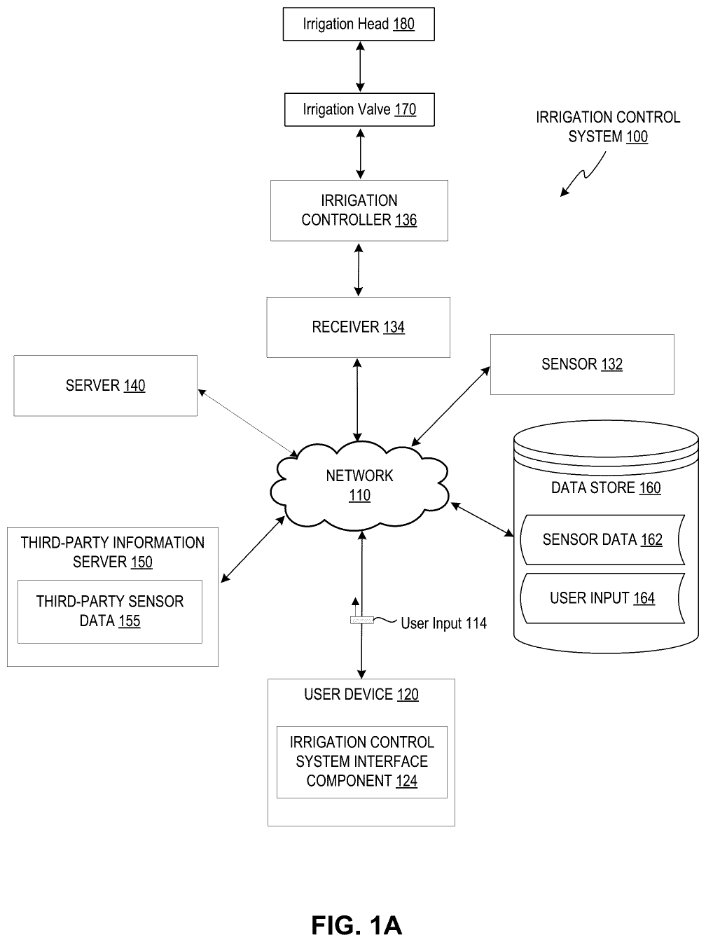

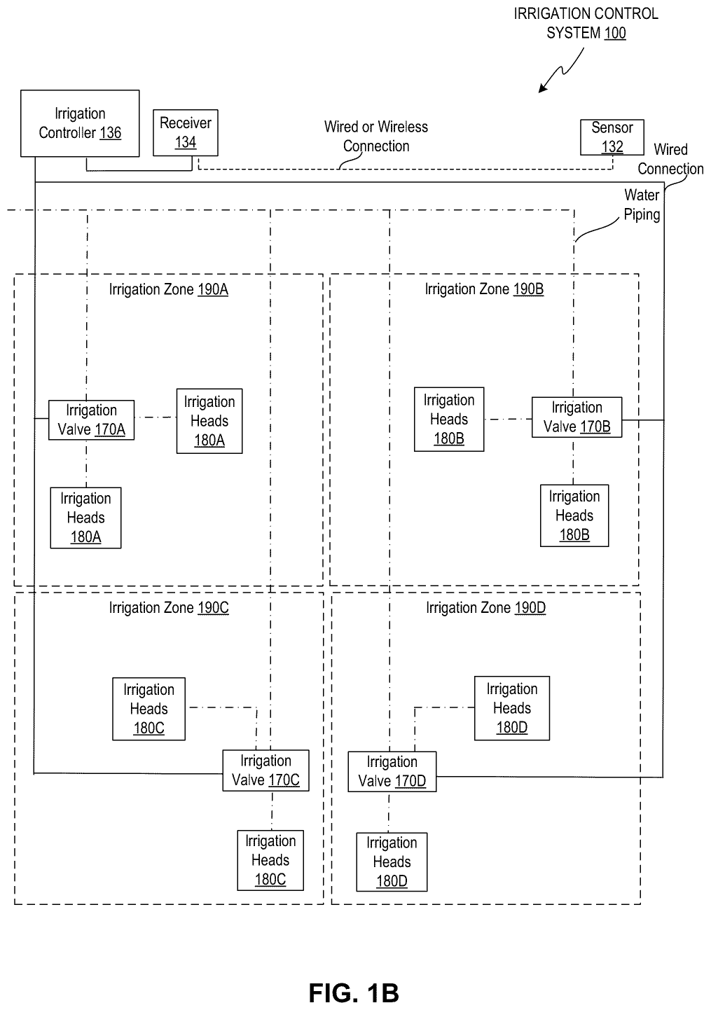

FIGS. 1A-B are block diagrams illustrating irrigation control systems 100, in accordance with some embodiments of the disclosure. FIG. 1A is a block diagram illustrating an example system architecture of an irrigation control system 100. FIG. 1B is a block diagram illustrating an example irrigation control system 100 used to irrigate irrigation zones 190. Elements with common numbering between FIGS. 1A-B may have similar functionalities and/or properties.

FIG. 1A is a block diagram illustrating an example system architecture of an irrigation control system 100, in accordance with some embodiments of the disclosure. The irrigation control system 100 may include a network 110, a user device 120, a sensor 132, a receiver 134, a server 140, a third-party information server 150, and a data store 160.

Network 110 may be a public network that provides a user device 120 with access to the server 140 and other publicly available computing devices. Network 110 may include one or more wide area networks (WANs), local area networks (LANs), wired networks (e.g., Ethernet network), wireless networks (e.g., an 802.11 network or a wireless local area network (WLAN)), cellular networks (e.g., a Long Term Evolution (LTE) network), routers, hubs, switches, server computers, and/or a combination thereof.

User device 120 may include computing devices such as personal computers (PCs), laptops, mobile phones, smart phones, tablet computers, netbook computers, network-connected televisions, etc. User device 120 may be capable of interacting with the receiver 134 and/or the sensor 132 by accessing the server 140. User device 120 may also be capable of receiving data from the server 140 and sending user input 114 to the server 140 and/or the receiver 134.

User device 120 may include an irrigation control system interface component 124 (e.g., a mobile app and/or web interface) for allowing the receiver 134 to receive user input 114 for proactively and reactively suspending or attenuating the flow of water from the irrigation control system 100. The irrigation control system interface component 124 may allow a user to customize their system by remotely programming and managing thresholds of the receiver 134. A user may provide user input 114 via the irrigation control system interface component 124 including a plurality of sets of environmental data (e.g., slope data, soil data, vegetation data, sunlight data, etc.). In some embodiments, each of the sets of environmental data may be associated with an irrigation zone of a plurality of irrigation zones.

The irrigation control system interface component 124 may also allow for a user-initiated remote suspension and/or attenuation of water flow of the irrigation control system 100. For example, a user may schedule a suspension/attenuation by time and date through selectable control options and/or user-input fields presented to the user in a scheduled events portion of the irrigation control system interface component 124. Or a user may initiate an immediate suspension or attenuation which lasts for a selected period of time. The irrigation control system interface component 124 may grant users the ability to cancel any existing suspension and/or attenuation of water flow.

The irrigation control system interface component 124 may allow a user to calculate estimated savings based on the irrigation control system 100 causing a suspension and/or attenuation of water flow for a certain period of time. For example, the savings could be estimated based on a user-entered irrigation area and the calculated increases and/or decreases in water consumption by the irrigation control system 100 with the adjustments that were made by the irrigation control system 100 relative to a theoretical baseline in which no adjustments would have been made. The user may gather this information through menus presented in the calculated savings portion of the irrigation control system interface component 124. The server can make the relevant calculations based on determining costs of the water used and actual or estimated water costs associated with a water supply agency.

The irrigation control system interface component 124 may grant users the ability to customize the water flow from their irrigation system through interface options (e.g., resume, pause, schedule events) presented in a water control section of the irrigation control system interface component 124 in order to conform to local water restrictions (e.g., restrictions on time of day, day of week, or duration of irrigation cycles responsive to drought or water shortages). The modification to water flow may be calculated automatically by the server 140, based on geolocation data gathered by the irrigation control system 100 or entered by the user. The user may also manually customize their irrigation control system 100 to conform to local water restrictions. The irrigation control system interface component 124 may be configured to notify a user when the user is close to utilizing a maximum level of irrigation for the month. In that case, the user can proactively suspend and/or attenuate the water flow accordingly. The control can be general controls (e.g., adjust the timing to start an irrigation event or the duration of water flow for all stations by a certain percentage), or station specific (e.g., adjust a single station a particular way, independent of the other stations). The controls also allow a user to set the irrigation control system 100's communication frequency during rain events.

The irrigation control system interface component 124 may also include a reporting and interfacing section that allows for access to real-time rain and humidity data, as well as historical data. The irrigation control system interface component 124 may allow users to generate and transmit reports of water use and detected rain data, as well as the estimated savings in costs and water usage. The irrigation control system interface component 124 may offer a user the option for push notifications (e.g., messages sent from the irrigation control system interface component 124 to the user device 120 to deliver timely information, updates, reminders, etc.) when a suspension and/or attenuation of the water flow takes place. The irrigation control system interface component 124 can be used to facilitate organization of a user's devices by account, site, and device.

The irrigation control system interface component 124 may also allow creation of ‘shared’ groups. For example, multiple users may share a single sensor 132 and the data provided by the sensor 132. This shared data from a single sensor 132 may be used to communicate with a single shared receiver 134 or with multiple receivers 134 corresponding to the plurality of users.

The sensor 132 may transmit sensor data 162 to the receiver 134 via the network 110 and/or the server 140. The sensor 132 may be a rain tipping device, a rainfall sensor, a soil moisture sensor device, a humidity sensor device, an imaging sensor (e.g., a camera), an infrared sensor, or any other type of sensor device that would provide relevant environmental data to determine an irrigation schedule. A rain tipping device may be a tipping bucket type rain gauge that uses a magnetic or optical sensor to detect each tip of the bucket and record it electronically. As the rain flows into the collector and fills up the bucket, the weight of the water causes the bucket to tip over, allowing the water to empty out. The sensor 132 may transmit sensor data 162 to the receiver 134 via a wired connection or via a wireless connection. The sensor 132 and how the sensor 132 operates within the irrigation control system 100 will be explained in further detail in connection with FIG. 1B.

The receiver 134 may be a receiver device capable of interfacing with an irrigation controller 136 (e.g., irrigation controller device) and the sensor 132 (e.g., sensor device). The receiver 134 may have a housing enclosing contacts and ports that may have wires to connect to the irrigation controller 136 and/or the sensor 132. The receiver 134 may have ports and/or terminals for power, connecting to the sensor 132, rain sensor ports, common interrupt ports, etc. The receiver 134 and how it operates within the irrigation control system 100 will be explained in further detail in connection with FIG. 1B.

The receiver 134 may be further connected to the irrigation controller 136. The irrigation controller may be connected to an irrigation valve 170, which may be connected to an irrigation head 180. These will be discussed in more detail in connection with FIG. 1B. Briefly, the sensor 132 (e.g., smart sensor) may receive sensor data 162 that is transmitted to the receiver 134 (e.g., smart receiver). The receiver 134 may then determine an action for the irrigation controller 136 (e.g., irrigation controller) to take responsive to user input 114 and sensor data. The sensor data 162 may also be shared with the user device 120 via the network 110 and server 140. The irrigation control system 100 may also receive third-party rain data 155 from a third-party information server 150 via the network 110.

The server 140 may facilitate wireless communication between the sensor 132 and the receiver 134. The server 140 may facilitate communication between the sensor 132, the receiver 134, and/or an irrigation control system interface component 124 (e.g., mobile app and/or web interface). The server 140 may store rain data and other sensor data 162 and third-party sensor data 162 150, as well as the communication and programming history for the irrigation control system 100. The server 140 may be configured to aggregate sensor data 162 gathered from any number of one or more sensors 132, as well as user input 114, to generate sensor data 162 (e.g., packets of sensor data) that are transmitted to the receiver 134. The generated sensor data 162 may include instructions for the receiver 134 to modify settings in the irrigation controller 136. In some embodiments, the generated sensor data 162 may be a weather condition (e.g., rain-related event data) and/or a current condition (e.g., event data) that is processed by the receiver 134 independently to determine how and when to adjust settings in the irrigation controller 136.

In some embodiments, the receiver 134 may either respond to instructions for modifying settings in the irrigation controller 136 and/or it can generate the instructions for modifying settings in the irrigation controller 136. These instructions may also be both proactive and reactive to events associated with the sensor data 162.

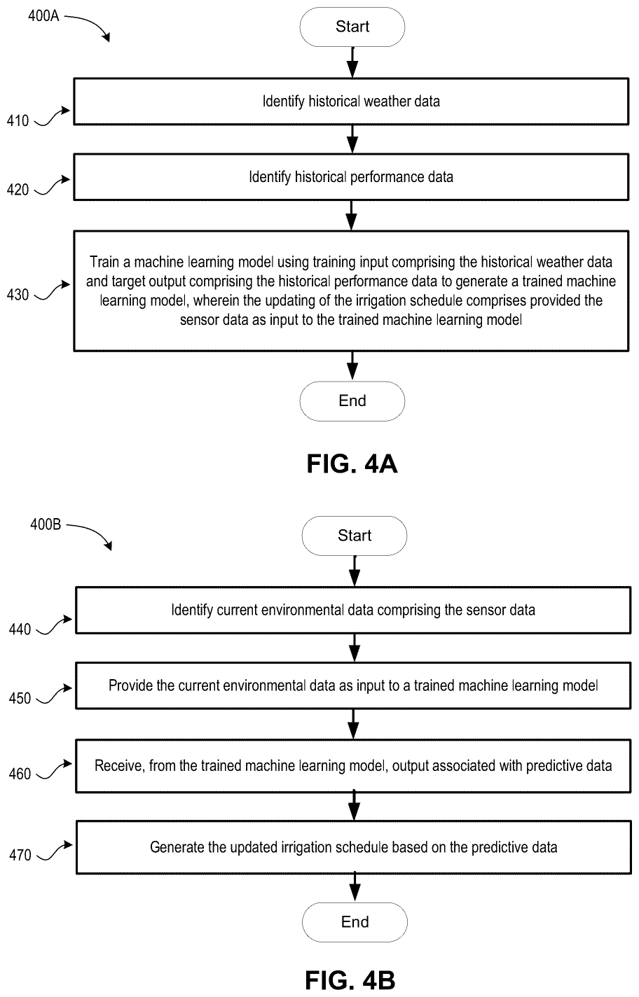

The server 140 may be configured to aggregate data gathered by the sensor 132 with data gathered by outside sources, such as artificial intelligence (AI) (e.g., trained machine learning model, see FIGS. 4A-B), open source, crowd sourcing, other third-party data, or any other available means. Such data may allow the server 140 to utilize predictive analytics to initiate a proactive suspension and/or attenuation of water flow.

In some embodiments, the server 140 may utilize AI to identify when rain is falling in a coverage area by using video images from doorbell cameras and/or any other streaming images. Social media posts that are determined to be contextually relevant in geographic location and time can also be processed for possible sensor data 162 related to rain-related events, such as images showing a thunderstorm.

The server 140 may also gather rainfall data from third-party sources (e.g., third-party information server 150) such as weather forecast sources (e.g., the National Oceanic and Atmospheric Administration (NOAA) open data datasets). The server 140 may also, for example, gather data from other third-party rain sensors. In those cases, the server 140 may aggregate the data and communicate to the receiver 134, which in turn interfaces with the irrigation controller 136 to modify the flow of water according to the received data. For example, if the server 140 gathers data from NOAA that there is an 80% chance of a rain event in the coverage area, the server 140 may communicate with the receiver component 134 to initiate a predictive suspension and/or attenuation of water flow. In that way, the present disclosure may be practiced without any sensor(s) (e.g., sensor 132). The third-party data gathered by the server 140 may be aggregated and used to communicate with the receiver 134 to modify the flow of water according to the data.

In some embodiments, the outside data gathered by the server 140 may be data other than rain or humidity data, but which is informative to a user's decision to modify water flow. For example, the server 140 may gather information about local restrictions on water usage or captured images showing distress of plants or vegetation in the coverage area. Additionally, images showing a user-related event (e.g., a current condition, such as a party or sporting event) may be used to determine that a pause should be applied to a scheduled irrigation cycle or a predetermined duration of time and/or until the user-related event ends. User calendar information may also be used to proactively modify an irrigation schedule. For instance, a user's calendar can be synced and used to detect a scheduled event and to proactively irrigate the area before the event and/or to pause the irrigation until after the scheduled event has concluded.

The server 140 may include conflict resolution rules that are applied and that weigh different events and sensor data 162 to accommodate different preferences. For instance, a detected distress of grass or other plants may outweigh a detected user event that is occurring in the area (e.g., an unscheduled gathering) and still cause the irrigation control system 100 to trigger or allow irrigation on the related area (e.g., irrigation zone). Likewise, an anticipated rainstorm that is being forecast can cause a continued pause in irrigation, despite a user-directed input that scheduled the sprinklers to run on a certain day (e.g., the day before the forecast rainstorm).

The server 140 may share the data that it gathers directly and/or from the sensor 132 with an open application programming interface (API) to allow other companies to have access to the sensor data 162 and integrate it into their own systems and processes.

Data store 160 may include sensor data 162 that stores one or more of data that are to be transmitted to receiver 134. Data store 160 may include user input 164 that stores data and instructions that are to be transmitted to irrigation control system 100.

The irrigation control system 100 of the present disclosure may facilitate Leadership in Energy and Environmental Design (LEED) certification for a business using the system.

Also claimed herein are methods for using an irrigation control system 100 to manage water flow. The claimed methods may also include receiving user input 114 for proactive, reactive, and/or customizable suspension and/or attenuation of water flow. For example, one embodiment may include using a sensor 132 to gather rain, humidity, and/or other data that is relevant to irrigation. In this embodiment, the sensor 132 may be in communication with the server 140, which receives the gathered data, and which is configured to gather third-party sensor data 155 of its own—for example, from outside sources via the third-party information server 150, such as AI, open source, crowdsource, data from other rain sensors, and/or other third-party data. The server 140 may communicate with the receiver 134, which interfaces with an irrigation controller 136 that is configured to control the water flow from, for example, an irrigation system. The server 140 may also be configured to receive user input 114 to proactively and reactively suspend and/or attenuate water flow. The receiver 134 may cause the irrigation controller 136 to modify water flow based on the data it receives from the server 140 and/or the sensor 132.

The various controller, receiver, server, sensor and other components that perform functionality that has been described herein may each include a separate processor and storage. In particular, each of these components may be viewed independently, or cooperatively as a computing device. The devices may be configured as an integrated or distributed computing system, as has been described.

In this regard, it will be appreciated that the disclosed methods may be practiced by a computer system comprising a computer including one or more processors and computer-readable media such as computer memory. In particular, the computer memory may store computer-executable instructions that when executed by one or more processors cause various functions to be performed, such as the acts recited in the embodiments.

FIG. 1B is a block diagram illustrating an example irrigation control system 100 as implemented with an irrigation system (e.g., a sprinkler system), in accordance with some embodiments of the disclosure. The irrigation control system 100 may include a smart sensor 132, a receiver 134, and an irrigation controller 136. The irrigation controller 136 may be connected to one or more irrigation valves 170A-D, and each irrigation valve 170A-D may be connected to one or more irrigation heads 180A-D.

The irrigation control system 100 may include electronics (e.g., irrigation controller 136) that are connected to the solenoids or other electronic controls for the irrigation valves 170A-D (e.g., valves) of an irrigation system (e.g., pressurized water system). The irrigation system may include one or more different irrigation zones 190A-D (e.g., irrigation stations), each having a different irrigation valve 170A-D that is controllable and operates in response to control settings of the irrigation controller 136. In particular, the irrigation controller 136 may selectively open or close the different irrigation valves 170A-D of the irrigation control system 100 to enable or prevent the flow of water through the different zones.

The irrigation controller 136 may also be connected to and/or integrated with a receiver 134. The receiver 134 may process sensor data 162 (e.g., data or input received by the sensor 132, smart sensor data) to cause the irrigation controller 136 to open or close different valves of the irrigation control system 100 at particular times and for particular durations based on the sensor data 162. The sensor data 162 collected by and/or processed by the receiver 134 may include rain-related sensor data 162 gathered by one or more rain, soil or humidity sensors, as well as other sensor data 162 (e.g., camera images) and third-party data (e.g., user-related calendar event data, weather forecasts, social media posts, etc.) that may be used to detect a weather condition (e.g., rain-related event) and/or a current condition (e.g., user-related event), as well as to evaluate the health and needs of the plants that are growing in the different areas affected by the irrigation control system 100.

The receiver 134 may be connected to and/or integrated within the irrigation controller 136. The receiver 134 may include a processing device (e.g., a processor) and storage. The storage may store the various sensor data 162 and control instructions that are executed by the processor of the receiver 134 to cause the receiver 134 to generate control signals to the irrigation controller 136 to adjust settings of the irrigation controller 136 for the different irrigation zones 190A-D controlled by the irrigation controller 136 (e.g., on/off settings, runtime settings, run duration settings, etc.).

The receiver 134 may also be connected to a remote server (e.g., the Server 140 of FIG. 1) that processes the sensor data 162 into a normalized format and/or a set of instructions for the receiver 134 to use when controlling the irrigation controller 136.

In some embodiments, the sensor data 162 processed by the receiver 134 may be transmitted from the sensor 132 that is configured to detect rain or humidity. The sensor 132 may detect rainfall in increments of as small as 0.01 inches or in other desired quantities. As the sensor 132 detects and measures humidity, rainfall, and other environmental data, the sensor 132 may generate sensor data 162 (e.g., packets of sensor data) that are transmitted to the receiver 134 at desired intervals. In some embodiments, the intervals are predetermined. In other embodiments, the sensor 132 may only provide sensor data 162 to the receiver 134 when queried for the sensor data 162 by the receiver 134. The sensor 132 may have a processor for processing the sensor data 162 and a storage for storing the sensor 132 data between different transmission intervals to the receiver 134.

The sensor 132 may also be pre-equipped with a transceiver to transmit the detected sensor data 162. Alternatively, the sensor 132 can be modified to include a transceiver to connect with the receiver 134 and to transmit detected sensor data 162.

In some embodiments, the sensor 132 may be a humidity sensor and/or a rainfall sensor. In other embodiments, the sensor 132 may be a soil moisture sensor. In yet other embodiments, the sensor 132 may be a camera which detects falling rain from images of the environment associated with the irrigation control system 100. The images captured by the camera sensor may be processed by the sensor 132, the receiver 134, and/or a server 140 to generate rain-related sensor data 162 that indicates when rain has been detected and that may also estimate a quantity of rain that has been detected in particular areas associated with the irrigation control system 100.

The image data may also be processed by any of the referenced systems, with trained AI models (e.g., trained machine learning model) that are trained using training data including historical sensor data (e.g., images of rainfall, pooling water, saturated plants, and/or cloud cover to determine when rain has fallen and is falling) and target output of performance data (e.g., historical quality of the vegetation resulting from historical irrigation schedules).

The image data may also be processed by any of the referenced systems, with trained AI models that are trained on training data related to plant health to evaluate relative plant hydration and to determine when plants growing in the area need more water or less water.

In some embodiments, the sensor 132 may include a thermometer that detects temperature. In some embodiments, multiple sensors 132 (e.g., different types of sensors 132) are used in irrigation control system 100.

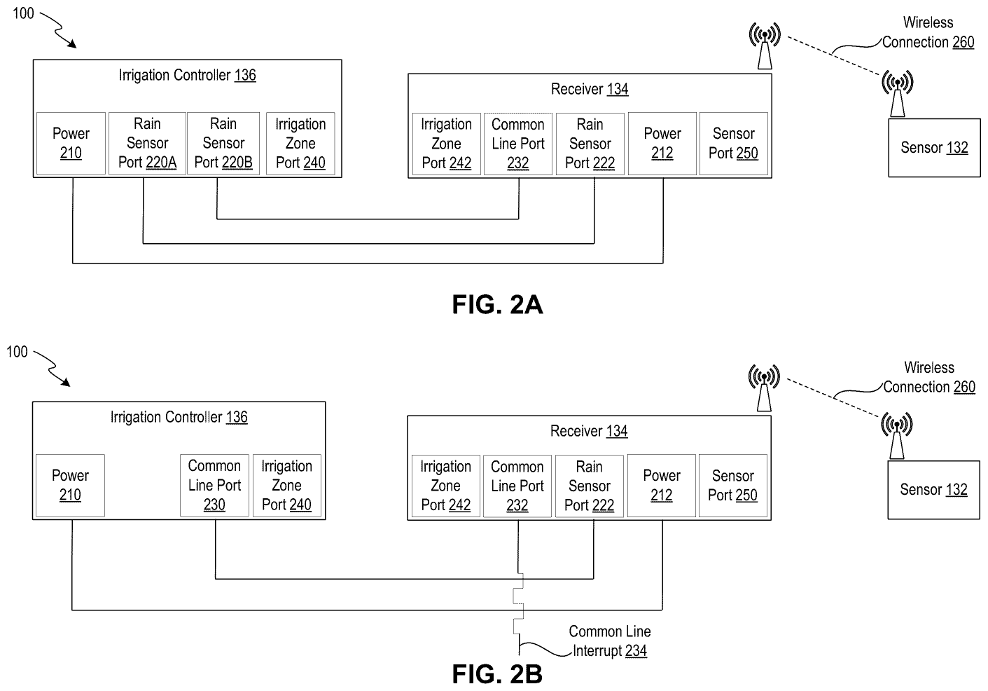

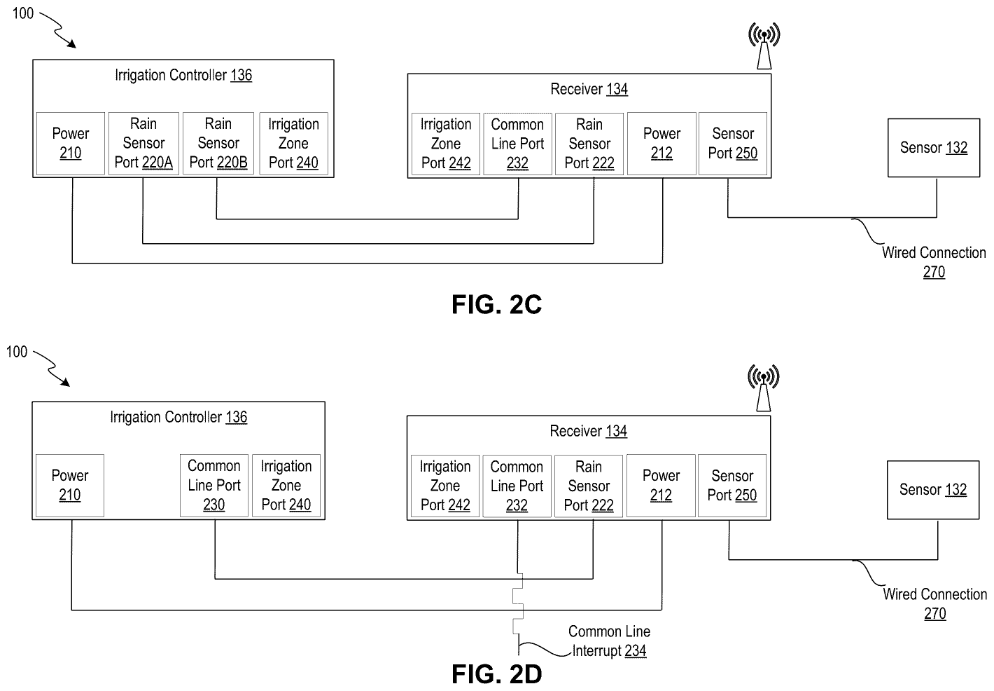

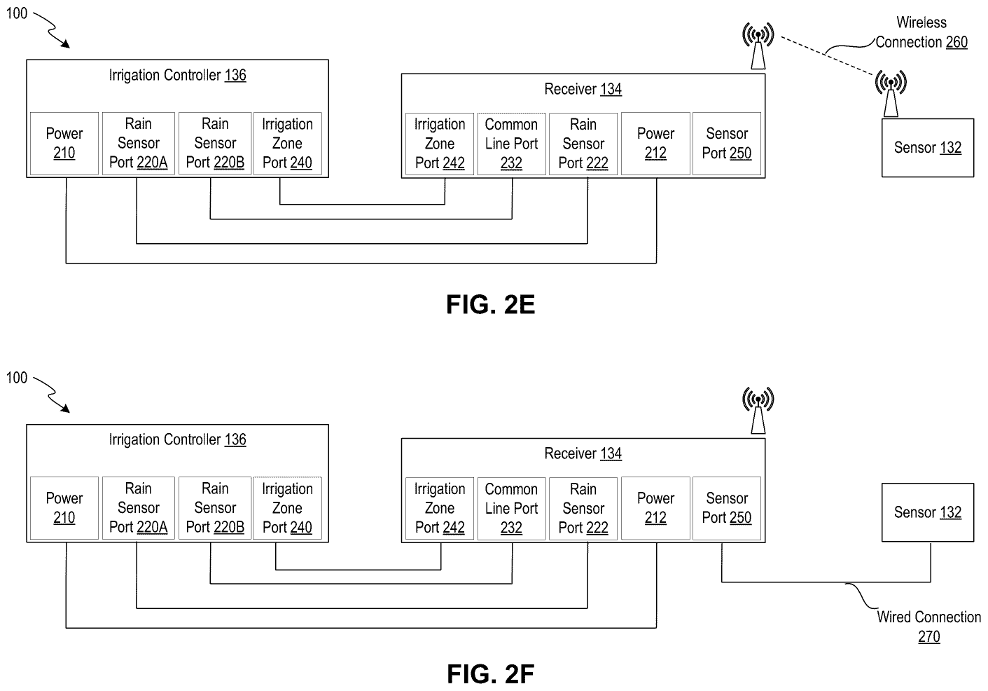

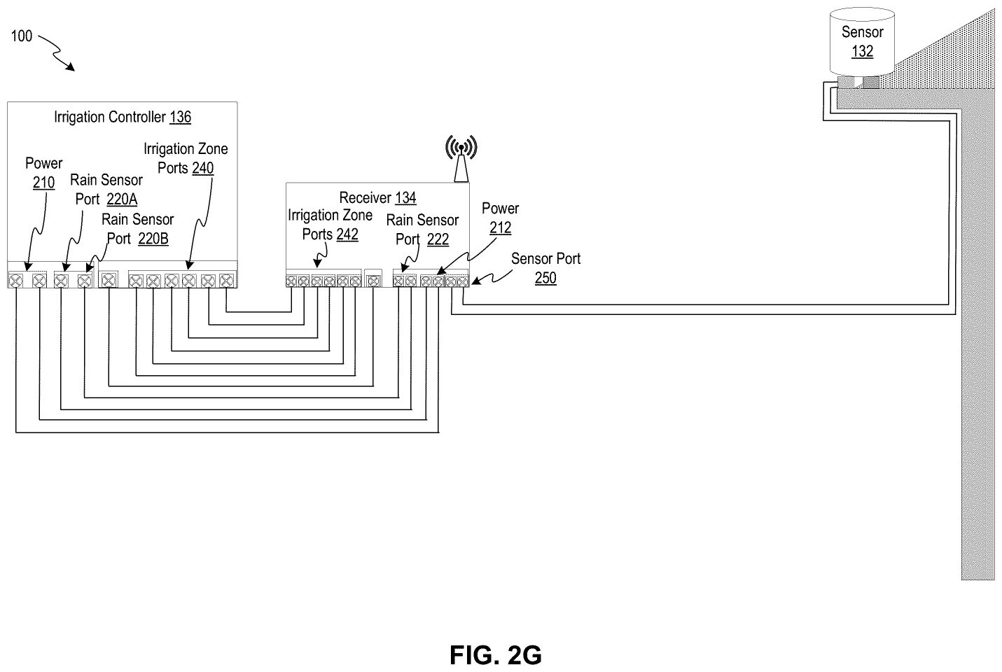

In some embodiments, the sensor 132 may have personal area network (PAN, e.g., Bluetooth®) and/or long range wide area network (LoRaWAN) capabilities. For example, the sensor 132 may communicate with the receiver 134 wirelessly, as described in connection with FIGS. 2A-B. Alternatively, the sensor 132 may communicate with the receiver 134 through a direct connection, as described in connection with FIGS. 2C-D.

In some embodiments, the sensor 132 may directly communicate with the receiver 134 wirelessly without going through a server 140. Or the receiver 134 may be part of the sensor 132.

In some embodiments, the sensor 132 may be configured to immediately detect rain. For example, the sensor 132 may detect rainfall in quantities as low as 0.01 inches. The sensor 132 may continue to monitor rainfall with high accuracy in, for example, 0.01 inch increments. The sensor 132 may use a tipping device, or any other device that will allow the sensor 132 to immediately detect and measure rainfall with high precision and accuracy. The sensor 132 may also, or alternatively, be configured to detect and monitor humidity. For example, the sensor 132 may include a moisture sensing device for measuring humidity levels in the area surrounding the sensor 132. Examples of such moisture sensing devices include hygrometers, psychrometers, or other humidity meters. The moisture sensing device of the sensor 132 may also be used by the system to determine when the rain or humidity event has passed and the regular schedule for water flow may resume.

In some embodiments, the sensor 132 is able to measure the ‘first drop’ of rain for a ‘quick pause’ option. For example, upon detecting the first drop of rain, the system may immediately suspend irrigation for the site. Then, irrigation may resume once the moisture sensing device of the sensor 132 no longer detects moisture and determines that the rain event has passed.

The sensor 132 may be configured to gather data other than rainfall or humidity data. For example, the sensor 132 may include a camera which can capture images relevant to irrigation strategy. For example, the sensor 132's camera may capture images of rainfall or of distress to plants or vegetation.

In some embodiments, the sensor 132 may have a replaceable power supply and/or a solar power supply. This may allow for remote placement of the sensor 132 (e.g., not in proximity to an electrical outlet). Furthermore, it may allow for regeneration of the power supply once the power has been depleted from the sensor 132. In other embodiments, the sensor 132 may have the option to directly connect to both power and sources of rain data.

The sensor 132 may be labeled with a PAN Identification (ID) (e.g., Bluetooth® ID) for authentication, geolocation, and security and efficiency in transmitting data from the sensor 132 to the server and/or the receiver 134.

In some embodiments, the sensor 132 may have a core program to initiate communication with the server 140 and/or cloud upon the first detection of rain, in order to help reduce power consumption and extend the battery life of the sensor 132. In other words, the sensor 132 may be configured such that it will not communicate with the server 140 and/or receiver 134 unless it detects rain, at which time it begins to communicate.

The sensor 132 may communicate both battery health and signal strength to the server. As such, a user may receive notifications when the sensor 132 battery power is low and/or its signal strength is weak. Either a low battery or intermittent signal strength may initiate an “SOS” to the server notifying a user of the issues.

The sensor 132 may be a distributed or a consolidated system.

In some embodiments, the sensor 132 may have a quick response code (e.g., QR Code®) that a user can scan to initiate an irrigation control system interface component (e.g., mobile app, the Irrigation Control System Interface Component 124 of FIG. 1A) download and/or establish device information and connect the sensor 132 to the receiver 134.

The sensor 132 may be dust resistant and water resistant up to 1 meter for up to 30 minutes (e.g., Ingress Protection 67 (IP67) water resistant). This may ensure a longer life of the sensor 132 which is exposed to the elements.

As discussed above, the irrigation control system 100 may include a receiver 134, which may communicate with the sensor 132 either wirelessly (as in FIGS. 2A-B) or through a direct connection (as in FIGS. 2C-D).

The receiver 134 may be the device that interfaces with the irrigation controller 136, which controls the flow of water. For example, the irrigation controller 136 may control the flow of water from irrigation heads 180A-B (e.g., a sprinkler or set of sprinklers). The receiver 134 may interface with the irrigation controller 136 through a direct connection, or it may interface with the irrigation controller 136 wirelessly.

The receiver 134 may be able to suspend and/or attenuate the water flow from the irrigation control system 100 by interfacing with the irrigation controller 136 by way of a rain sensor port on the irrigation controller 136, and/or by interrupting the common wire to the irrigation controller 136, (as shown in FIGS. 2A-B). Through a common wire, the receiver 134 can ‘pause’ the irrigation controller 136 by breaking the circuit of the common wire to the valves on the irrigation controller 136 using a common interrupt.

The receiver 134 may be configured to communicate with a server (e.g., server 140 of FIG. 1). The server 140 may communicate to the receiver 134 a decision for suspension/attenuation of the water flow, based on the data it has received and aggregated. The receiver 134 may also be configured to communicate with the cloud wirelessly to directly gather data from outside sources, such as AI, open source, crowdsourcing, and/or other third-party data.

The receiver 134 may have terminals for connecting to a power supply, the sensor 132, and/or to rain sensor ports on the irrigation controller 136. The receiver 134 may run on 24 volts of alternating current (AC) power.

In some embodiments, the receiver 134 has a QR Code® that a user can scan to initiate the irrigation control system interface component 124 (e.g., mobile app) download and/or establish device information and to connect the receiver 134 to a user-related profile and irrigation control system interface component 124 (e.g., web interface or mobile app).

The receiver 134 may be water resistant (e.g., IP67 water resistant). This may allow a longer life of the receiver 134 which may be exposed to the elements.

FIGS. 2A-G illustrate irrigation control systems 100, in accordance with some embodiments of the disclosure. FIG. 2A illustrates an example irrigation control system 100 implementing a wireless connection between a sensor 132 and a receiver 134 and utilizing rain ports. FIG. 2B illustrates an example irrigation control system 100 implementing a wireless connection between a sensor 132 and a receiver 134 and utilizing a common line interrupt. FIG. 2C illustrates an example irrigation control system 100 implementing a wired connection between a sensor 132 and a receiver 134 and utilizing rain ports. FIG. 2D illustrates an example irrigation control system 100 implementing a wired connection between a sensor 132 and a receiver 134 and utilizing a common line interrupt. FIG. 2E illustrates an example irrigation control system 100 implementing a wireless connection between a sensor 132 and a receiver 134 and utilizing one or more irrigation zone ports. FIG. 2F illustrates an example irrigation control system 100 implementing a wired connection between a sensor 132 and a receiver 134 and utilizing one or more irrigation zone ports. FIG. 2G illustrates an example irrigation control system 100 implementing station ports. Elements with common numbering between FIGS. 2A-F may have similar functionality and/or properties. Elements of FIGS. 2A-F with common numbering with elements of FIGS. 1A-B may have similar functionality and/or properties.

FIG. 2A illustrates an example irrigation control system 100 implementing a wireless connection 260 between a sensor 132 and a receiver 134 and utilizing rain sensor ports 220A-B of an irrigation controller 136 and a rain sensor port 222 and a common line port 232 of the receiver 134, in accordance with an embodiment of the disclosure. In some embodiments, the rain sensor port 220A of the irrigation controller 136 may connect to the rain sensor port 222 of the receiver 134, and the rain sensor port 220B of the irrigation controller 136 may connect to the common line port 232 of the receiver 134. The aforementioned connections may be a wired connection that allows to receiver 134 to cause irrigation of one or more irrigation zones by the irrigation controller 136.

FIG. 2B illustrates an example irrigation control system 100 implementing a wireless connection 260 between a sensor 132 and a receiver 134 and utilizing a common line port 230 of an irrigation controller 136 and a rain sensor port 222 and a common line port 232 of the receiver 134, in accordance with an embodiment of the disclosure. In some embodiments, the common line port 230 of the irrigation controller 136 may connect to the rain sensor port 222 of the receiver via a wired connection. In some embodiments, the common line port 232 of the receiver 134 may provide a common line interrupt 234 to the one or more irrigation zones.

FIG. 2C illustrates an example irrigation control system 100 implementing a wired connection 270 between a sensor 132 and a receiver 134 and utilizing rain sensor ports 220A-B of an irrigation controller 136 and a rain sensor port 222 and a common line port 232 of the receiver 134, in accordance with an embodiment of the disclosure. In some embodiments, the rain sensor port 220A of the irrigation controller 136 may connect to the rain sensor port 222 of the receiver 134, and the rain sensor port 220B of the irrigation controller 136 may connect to the common line port 232 of the receiver 134. The aforementioned connections may be a wired connection that allows to receiver 134 to cause irrigation of one or more irrigation zones by the irrigation controller 136.

FIG. 2D illustrates an example irrigation control system 100 implementing a wired connection 270 between a sensor 132 and a receiver 134 and utilizing a common line port 230 of an irrigation controller 136 and a rain sensor port 222 and a common line port 232 of the receiver 134, in accordance with an embodiment of the disclosure. In some embodiments, the common line port 230 of the irrigation controller 136 may connect to the rain sensor port 222 of the receiver via a wired connection. In some embodiments, the common line port 232 of the receiver 134 may provide a common line interrupt 234 to the one or more irrigation zones.

FIG. 2E illustrates an example irrigation control system 100 implementing a wireless connection 260 between a sensor 132 and a receiver 134 and connecting one or more irrigation zone ports 240 of an irrigation controller 136 to one or more irrigation zone ports 242 of the receiver 134 via a wired connection, in accordance with an embodiment of the disclosure. In some embodiments, the connection between the one or more irrigation zone ports 240 of the irrigation controller 136 to the one or more irrigation zone ports 242 of the receiver 134 allows the irrigation controller 136 to independently control one or more irrigation zones responsive to an irrigation schedule received from the receiver 134.

FIG. 2F illustrates an example irrigation control system 100 implementing a wired connection 270 between a sensor 132 and a receiver 134 and connecting one or more irrigation zone ports 240 of an irrigation controller 136 to one or more irrigation zone ports 242 of a receiver 134 via a wired connection, in accordance with an embodiment of the disclosure. In some embodiments, the connection between the one or more irrigation zone ports 240 of the irrigation controller 136 to the one or more irrigation zone ports 242 of the receiver 134 allows the irrigation controller 136 to independently control one or more irrigation zones responsive to an irrigation schedule received from the receiver 134.

FIG. 2G illustrates an example irrigation control system 100 implementing station ports. In FIG. 2G, receiver 134, of irrigation control system 100 may generate an updated schedule of adjusting time duration of irrigation of irrigation zones separate from each other (e.g., different amounts of time duration, different percentages of original time durations, etc.). For example, responsive to rainfall, the rain may gather in one irrigation zone (e.g., due to slope of the irrigation zones) and the receiver may cause that irrigation zone to have a shorter time duration (e.g., lower percentage of original time duration) compared to the other irrigation zones.

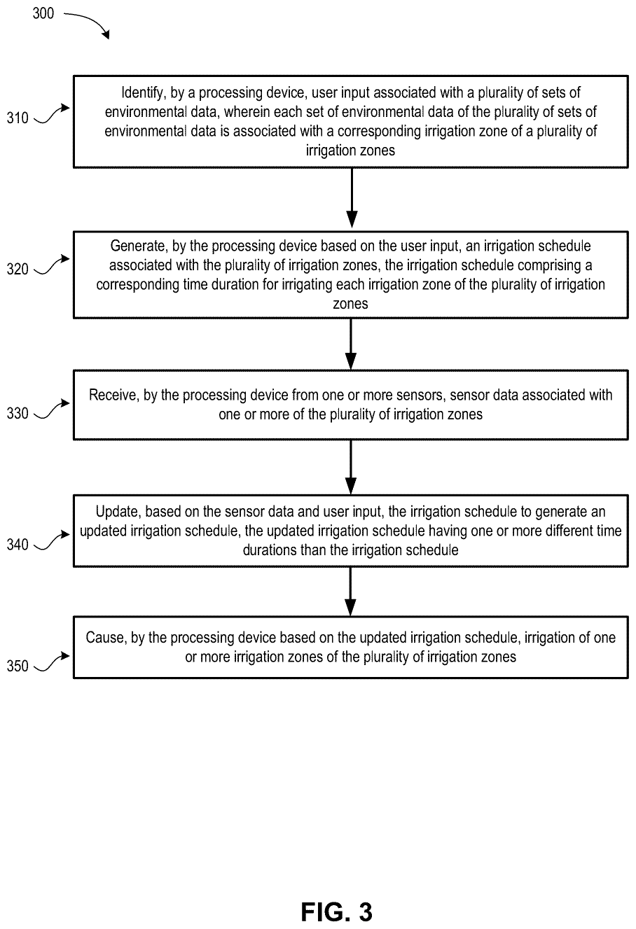

FIGS. 3 and 4A-B illustrate methods 300, 400A, and 400B respectively. Methods 300, 400A, and/or 400B and/or each of the aforementioned methods' individual functions, routines, subroutines, or operations can be performed by a processing device (e.g., of receiver 134, of server 140, of user device 120), having one or more processing units (CPU) and memory devices communicatively coupled to the CPU(s). In some embodiments, the aforementioned methods can be performed by a single processing thread or alternatively by two or more processing threads, each thread executing one or more individual functions, routines, subroutines, or operations of the method. The aforementioned methods as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, methods 300, 400A, and 400B are performed by irrigation control system 100 (e.g., receiver 134) described in FIGS. 1A-B. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed. It may be noted that elements of FIGS. 1A-B and 2A-G may be used herein to help describe FIGS. 3-4B.

FIG. 3 is a flow diagram illustrating a method 300 of controlling irrigation control systems, in accordance with some embodiments of the disclosure.

At operation 310 of method 300, a processing device identifies user input associated with a plurality of sets of environmental data. The processing device may be of a receiver (e.g., the Receiver 134 of FIG. 1A), a server (e.g., the Server 140 of FIG. 1A), a sensor (e.g., the Sensor 132 of FIG. 1A), a user device (e.g., the User Device 120 of FIG. 1A), or other such processing devices utilized in an irrigation control system. In some embodiments, each set of environmental data of the plurality of sets of environmental data may be associated with a corresponding irrigation zone of a plurality of irrigation zones. In some embodiments, the processing device may identify the user input by receiving the user input from a user device via a wireless network. In some embodiments, the set of environmental data may include one or more of slope data, soil data, vegetation data, or sunlight data associated with an area to be irrigated (e.g., the one or more irrigation zones of the plurality of irrigation zones). For example a first set of environmental data for the first irrigation zone may include one or more of slope data, soil data, vegetation data, and/or sunlight data for the first irrigation zone. In some embodiments, the user input may include an estimate of a time duration (e.g., and time of day) to provide irrigation for each irrigation zone.

In some embodiments, the irrigation control system includes a sensor (e.g., rain sensor) that has built-in Bluetooth capabilities to communicate with a user device (e.g., mobile app) for setup. In some embodiments, the sensor (e.g., rain sensor) has a unique identification code to simplify initial setup. In some embodiments, the sensor (e.g., rain sensor) has built-in LoRaWAN to facilitate communication to the receiver or a server (e.g., the cloud). In some embodiments, upon initial setup of the sensor (e.g., rain sensor), the sensor is to communicate to the receiver and/or to a server (e.g., the cloud). User input may indicate whether the sensor is to communicate to the receiver and/or a server. If the sensor is communicating with a server, the sensor may identify which network (e.g., service provider) has a strongest signal (e.g., wireless signal) and provide an indication of such to the user device.

Responsive to being setup, a user interface (e.g., the Irrigation Control System Interface Component 124 of FIG. 1A, which may be e.g., of a processing device, of a user device, of the receiver, of the server, etc.) may prompt a user to enter site (e.g., irrigation zone) information (e.g., slope data, soil data, vegetation data, sunlight data, soil type, plant type, root depth, slope, etc.). The site data may be used (e.g., by the server, by the user device, by the receiver) to determine a length of rain pause (e.g., how long to pause irrigation and/or how to update the schedule based on sensor data). The user interface (e.g., of a user device, of the receiver, etc.) may provide a guide to help the user determine settings (e.g., duration of irrigation, time of irrigation, days of irrigation, etc.) for the irrigation zones. The user interface (e.g., of a user device, of the receiver, etc.) may allow customization of settings to meet site-specific needs (e.g., based on plant data, soil data, slope data, sunlight data, etc.). The user interface (e.g., of a user device, of the receiver, etc.) may allow for the creation of a site (e.g., of irrigation zones). The user interface may allow for multiple sensors (e.g., multiple rains sensors) on a site. The user interface may provide a mapping feature to locate a sensor on a sitemap. The user interface may allow a user to determine communication thresholds and frequency (e.g., how frequent for the sensor to communicate with the receiver and/or server). The user interface may allow configuration of notification preferences (e.g., notify the user device and/or receiver if rain takes place, if thresholds for a “quick pause” are met, if thresholds for a “smart pause” are met, etc.). The user interface may provide rainfall totals and associated “pause” information for given periods of time. The user interface may provide an option of sharing sensor data (e.g., rain data) with other devices (e.g., other user devices, other receivers, other irrigation controllers, etc.). All of the above examples of user interface operations may be part of the user input.

At operation 320 of method 300, the processing device may generate, based on the user input, an irrigation schedule associated with the plurality of irrigation zones. The irrigation schedule may include a corresponding time duration (e.g., and time of day) for irrigating each irrigation zone of the plurality of irrigation zones. In some embodiments, the processing device generates the irrigation schedule further based on sensor data (e.g., image data of the slope of the irrigation zone, image data of the types of vegetation in the irrigation zone, etc.).

At operation 330 of method 300, the processing device may receive, from one or more sensors (e.g., sensor 132 of one or more of FIGS. 1A-2F), sensor data associated with one or more of the plurality of irrigation zones. In some embodiments, the one or more sensors may include at least one of a rainfall sensor, a humidity sensor, a soil moisture sensor, an imaging sensor, and/or an infrared sensor. In some embodiments, the sensor data may correspond to rainfall of about 0.01 inches to about 0.05 inches. In some embodiments, the sensor may only report sensor data once a threshold value (e.g., threshold rainfall value of at least 0.01 inches per sensing interval) has been met. In some embodiments, the processing device may be of a receiver, which only receives sensor data once the threshold value has been met.

At operation 340 of method 300, the processing device may update, based on the sensor data and the user input, the irrigation schedule to generate an updated irrigation schedule, the updated irrigation schedule having one or more different time durations than the irrigation schedule (e.g., different than the original time durations of the irrigation schedule of operation 320). In some embodiments, the one or more different time durations of the updated irrigation schedule may be a reduced time duration of the irrigation schedule. The reduced time duration may be greater than 0% of the time duration of the irrigation schedule and less than 100% of the time duration of the irrigation schedule. For example, the updated irrigation schedule may cause the irrigation schedule to be reduced to 50% of it's usual duration (e.g., reduced from 10 minutes of watering per irrigation zone to 5 minutes of watering per irrigation zone). In some embodiments, the one or more different time durations of the updated irrigation schedule may include a first different time duration (e.g., first percentage of the first original time duration of the irrigation schedule of operation 320) corresponding to a first irrigation zone of the plurality of irrigation zones and a second different time duration (e.g., second percentage of the second original time duration of the irrigation schedule of operation 320) corresponding to a second irrigation zone of the plurality of irrigation zones, where the first different time duration being different from the second different time duration (e.g., the first percentage and the second percentage are different from each other). For example, the updated irrigation schedule may reduce the watering of a first irrigation zone from 10 minutes to 5 minutes based on environmental needs and may reduce the watering of a second irrigation zone from 10 minutes to 1 minute based on environmental needs. Such environmental needs may include ponding, flooding, dying vegetation, and other environmental data associated with the health and water needs of an irrigation zone.

In some embodiments, the processing device may further receive event data, wherein updating the irrigation schedule is further based on the event data. Event data may include an unscheduled or scheduled activity taking place in the area to be irrigated (e.g., an outdoor gathering, a birthday party, soccer practice, etc.). In some embodiments, the processing device may further receive user input including a threshold rainfall value associated with generating an updated irrigation schedule (e.g., a user input indicating that the irrigation schedule should not be updated until a certain amount of rainfall has been achieved). The threshold rainfall value may be based on an increment of about 0.01 inches and starting at 0.01 inches per sensing interval (e.g., the user input may indicate that the irrigation schedule should be updated when rainfall has reached a minimum of 0.01 inches). In some embodiments, the user input may further include a pause duration, with the irrigation schedule being updated based on the pause duration (e.g., a user input indicating that the irrigation schedule should be paused for a certain period of time after sensor data has indicated rainfall).

At operation 350 of method 300, the processing device may cause, based on the updated irrigation schedule, irrigation of one or more irrigation zones of the plurality of irrigation zones.

FIGS. 4A-B are flow diagrams illustrating methods of training and using a machine learning model, in accordance with some embodiments of the disclosure. FIG. 4A is a flow diagram illustrating an example method of training a machine learning model to be used by a receiver (e.g., receiver 134) of an irrigation control system. FIG. 4B is a flow diagram illustrating an example method of using a trained machine learning model by a receiver (e.g., receiver 134) of an irrigation control system to update an irrigation schedule.

FIG. 4A is a flow diagram illustrating an example method 400A of training a machine learning model to be used by a receiver of an irrigation control system (e.g., the receiver 134 of the irrigation control system 100 of FIG. 1A). In some embodiments, the training of the machine learning model is performed by one or more of a server, a processing device of a receiver, user device, etc.

At operation 410 of method 400A, the processing device may identify historical environmental data. In some embodiments, environmental data may include one or more of what an environment looks like when it is raining, past weather forecasts and associated data, historical sensor data (e.g., from sensor 132) (e.g., during previous rain events, historical image data of vegetation and/or precipitation condition), etc.

At operation 420 of method 400A, the processing device may identify historical performance data. In some embodiments, historical performance data may include a previous irrigation schedule and a resulting vegetation health of an associated irrigation area. For example, historical performance data may include a schedule where all irrigation zones received 5 minutes of irrigation with a result of grass in the irrigation zone dying from dehydration. Another example may include a schedule where all irrigation zones received 20 minutes of irrigation with a result of grass in the irrigation zone being flooded.

At operation 430 of method 400A, the processing device may train a machine learning model using training input including the historical environmental data and target output including the historical performance data to generate a trained machine learning model. In some embodiments, updating the irrigation schedule (e.g., operation 340 of FIG. 3) includes providing sensor data as input to the trained machine learning model.

FIG. 4B is a flow diagram illustrating an example method 400B of using a trained machine learning model by a receiver of an irrigation control system (e.g., the receiver 134 of the irrigation control system 100 of FIG. 1A) to update an irrigation schedule.

At operation 440 of method 400B, a processing device may identify current environmental data (e.g., current sensor data from sensor 132). In some embodiments, current environmental data may include one or more of what an environment looks like, current weather conditions, current weather forecasts, current sensor data (e.g., from sensor 132) (e.g., during current rain events, current image data of vegetation and/or precipitation condition), etc.

At operation 450 of method 400B, the processing device may provide the current environmental data (e.g., current sensor data) as input to a trained machine learning model. In some embodiments, the trained machine learning model was by method 400A of FIG. 4A.

At operation 450 of method 400B, the processing device may receive, from the trained machine learning model, output associated with predictive data.

At operation 460 of method 400B, the processing device may generate the updated irrigation schedule based on the predictive data. The processing device may cause irrigation based on the updated irrigation schedule.

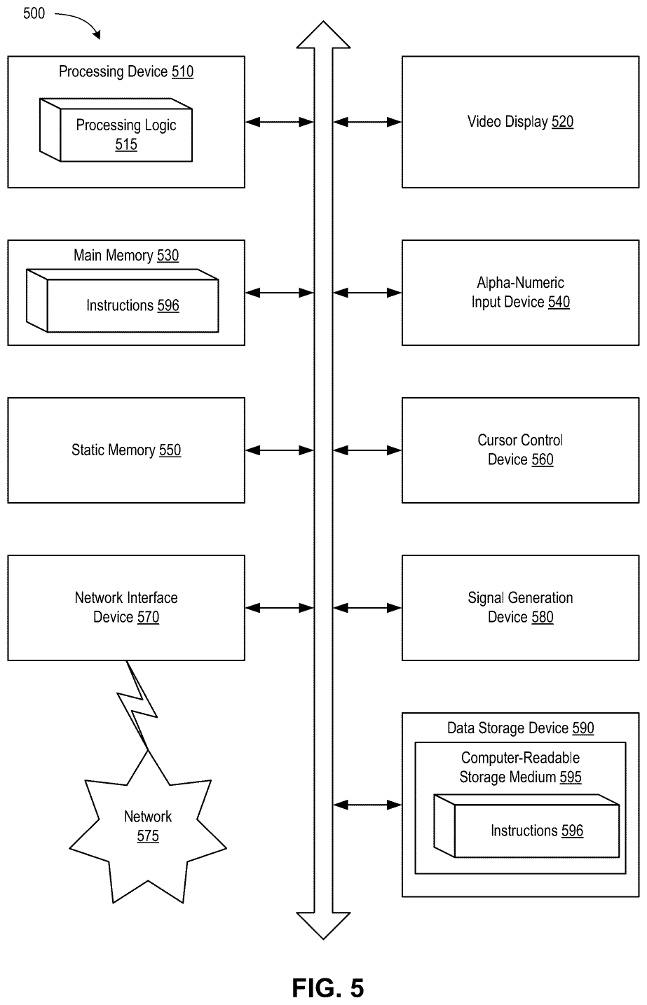

FIG. 5 is a block diagram illustrating an example computer system 500, in accordance with some embodiments of the disclosure. The computer system 500 executes one or more sets of instructions that cause the computer to perform any one or more of the methodologies discussed herein. Set of instructions, instructions, and the like may refer to instructions that, when executed by computer system 500, cause computer system 900 to perform one or more operations of the irrigation control system 100 of FIG. 1. The computer may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 500 includes a processing device 510, a main memory 530 (e.g., read-only memory (ROM), flash memory, dynamic random access memory (DRAM) such as synchronous DRAM (SDRAM) or Rambus DRAM (RDRAM), etc.), a static memory 550 (e.g., flash memory, static random access memory (SRAM), etc.), and a data storage device 590, which communicate with each other via a bus.

The processing device 510 represents one or more general-purpose processing devices such as a microprocessor, central processing unit, or the like. More particularly, the processing device 510 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 510 may also be one or more special-purpose processing devices such as an application specific integrated circuit (ASIC), a field programmable gate array (FPGA), a digital signal processor (DSP), network processor, or the like. The processing device 510 is configured to execute instructions of the irrigation control system 100 for performing the operations discussed herein.

The computer system 500 may further include a network interface device 570 that provides communication with other machines over a network 575, such as a local area network (LAN), an intranet, an extranet, or the Internet. The computer system 500 also may include a video display 520 (e.g., a liquid crystal display (LCD) or a cathode ray tube (CRT)), an alpha-numeric input device 540 (e.g., a keyboard), a cursor control device 560 (e.g., a mouse), and a signal generation device 580 (e.g., a speaker).

The data storage device 590 may include a non-transitory computer-readable storage medium 595 on which is stored the sets of instructions of the irrigation control system 100 and/or server 140 embodying any one or more of the methodologies or functions described herein. The sets of instructions 596 of the irrigation control system 100 and/or server 140 may also reside, completely or at least partially, within the main memory 530 and/or within the processing device 510 during execution thereof by the computer system 500, the main memory 530 and the processing device 510 also constituting computer-readable storage media. The sets of instructions 596 may further be transmitted or received over the network 575 via the network interface device 570.

While the example of the computer-readable storage medium 595 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “identifying”, “generating”, “receiving”, “updating”, “causing”, “providing”, “training”, or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation. When the term “about,” “substantially,” or “approximately” is used herein, this is intended to mean that the nominal value presented is precise within ±2%, ±5%, ±7%, ±10%, ±12%, ±15%, ±17%, or ±20%.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method comprising:
identifying, by a processing device, user input associated with a plurality of sets of environmental data, wherein each set of environmental data of the plurality of sets of environmental data is associated with a corresponding irrigation zone of a plurality of irrigation zones;
generating, by the processing device based on the user input, an irrigation schedule associated with the plurality of irrigation zones, the irrigation schedule comprising a corresponding time duration for irrigating each irrigation zone of the plurality of irrigation zones;
receiving, by the processing device from one or more sensors, sensor data associated with one or more of the plurality of irrigation zones;
updating, based on the sensor data and the user input, the irrigation schedule to generate an updated irrigation schedule, the updated irrigation schedule having one or more different time durations than the irrigation schedule; and
causing, by the processing device based on the updated irrigation schedule, irrigation of one or more irrigation zones of the plurality of irrigation zones.

2. The method of claim 1, wherein the processing device is of a receiver of an irrigation control system.

3. The method of claim 1, wherein the identifying of the user input comprises receiving, by the processing device, the user input from a user device via a wireless network.

4. The method of claim 1, wherein each of the plurality of sets of environmental data comprises one or more of slope data, soil data, vegetation data, or sunlight data.

5. The method of claim 1, wherein the one or more sensors comprise at least one of a rainfall sensor, a humidity sensor, a soil moisture sensor, an imaging sensor, or an infrared sensor.

6. The method of claim 1, wherein the causing of the irrigation of the one or more irrigation zones comprises transmitting, by the processing device, to an irrigation controller device, instructions associated with the updated irrigation schedule.

7. The method of claim 1, wherein the one or more different time durations of the updated irrigation schedule is a reduced time duration of the irrigation schedule, the reduced time duration being greater than 0% of an original time duration of the irrigation schedule and less than 100% of the original time duration of the irrigation schedule.

8. The method of claim 1, wherein the one or more different time durations of the updated irrigation schedule comprises a first different time duration corresponding to a first irrigation zone of the plurality of irrigation zones and a second different time duration corresponding to a second irrigation zone of the plurality of irrigation zones, the first different time duration being different from the second different time duration.

9. The method of claim 8, wherein:
for the first irrigation zone, the first different time duration of the updated irrigation schedule is a first percentage of a first original time duration of the irrigation schedule;
for the second irrigation zone, the second different time duration of the updated irrigation schedule is a second percentage of a second original time duration of the irrigation schedule; and
the first percentage is different than the second percentage.

10. The method of claim 1 further comprising:
identifying historical environmental data;
identifying historical performance data; and
training a machine learning model using training input comprising the historical environmental data and target output comprising the historical performance data to generate a trained machine learning model, wherein the updating of the irrigation schedule comprises providing the sensor data as input to the trained machine learning model.

11. The method of claim 1, wherein the updating of the irrigation schedule comprises:
identifying current environmental data comprising the sensor data;
providing the current environmental data as input to a trained machine learning model;
receiving, from the trained machine learning model, output associated with predictive data; and
generating the updated irrigation schedule based on the predictive data.

12. The method of claim 1 further comprising receiving, by the processing device, event data, wherein the updating of the irrigation schedule is further based on the event data.

13. The method of claim 1, wherein the user input comprises a user indication of a threshold rainfall value based on an increment of about 0.01 inches, and wherein the updating of the irrigation schedule is based on the user indication of the threshold rainfall value.

14. The method of claim 1, further comprising receiving, by the processing device, a pause duration, wherein the updating of the irrigation schedule is further based on the pause duration.

15. A system comprising:
a memory; and
a processing device coupled to the memory, the processing device to:
identify user input associated with a plurality of sets of environmental data, wherein each set of environmental data of the plurality of sets of environmental data is associated with a corresponding irrigation zone of a plurality of irrigation zones;
generate, based on the user input, an irrigation schedule associated with the plurality of irrigation zones, the irrigation schedule comprising a corresponding time duration for irrigating each irrigation zone of the plurality of irrigation zones;
receive, from one or more sensors, sensor data associated with one or more of the plurality of irrigation zones;
update, based on the sensor data and the user input, the irrigation schedule to generate an updated irrigation schedule, the updated irrigation schedule having one or more different time durations than the irrigation schedule; and
cause, based on the updated irrigation schedule, irrigation of one or more irrigation zones of the plurality of irrigation zones.

16. The system of claim 15, wherein the one or more different time durations of the updated irrigation schedule is a reduced time duration of the irrigation schedule, the reduced time duration being greater than 0% of an original time duration of the irrigation schedule and less than 100% of the original time duration of the irrigation schedule.

17. The system of claim 15, wherein to cause the irrigation of the one or more irrigation zones, the processing device is to transmit instructions associated with the updated irrigation schedule to an irrigation controller device.

18. A non-transitory computer-readable medium comprising instructions that, responsive to execution by a processing device, cause the processing device to perform operations comprising:
identifying user input associated with a plurality of sets of environmental data, wherein each set of environmental data of the plurality of sets of environmental data is associated with a corresponding irrigation zone of a plurality of irrigation zones;
generating, based on the user input, an irrigation schedule associated with the plurality of irrigation zones, the irrigation schedule comprising a corresponding time duration for irrigating each irrigation zone of the plurality of irrigation zones;
receiving, from one or more sensors, sensor data 162 associated with one or more of the plurality of irrigation zones;
updating, based on the sensor data and the user input, the irrigation schedule to generate an updated irrigation schedule, the updated irrigation schedule having one or more different time durations than the irrigation schedule; and
causing, based on the updated irrigation schedule, irrigation of one or more irrigation zones of the plurality of irrigation zones.

19. The non-transitory computer-readable medium of claim 18, wherein the one or more different time durations of the updated irrigation schedule is a reduced time duration of the irrigation schedule, the reduced time duration being greater than 0% of an original time duration of the irrigation schedule and less than 100% of the original time duration of the irrigation schedule.

20. The non-transitory computer-readable medium of claim 18, wherein the causing of the irrigation of the one or more irrigation zones comprises transmitting, by the processing device, to an irrigation controller device, corresponding instructions associated with the updated irrigation schedule.
